(19) United States
(12) Patent Application Publication
(10) Pub. No.: US 2019/0205647 A1
(43) Pub. Date: Jul. 4, 2019

(54) SYSTEMS AND METHODS FOR INTEGRATED AUGMENTED REALITY

(71) Applicant: Shiftsmart, Inc., San Francisco, CA (US)

(72) Inventor: Aakash Kumar, Stanford, CA (US)

(21) Appl. No.: 16/236,531

(22) Filed: Dec. 30, 2018

Related U.S. Application Data
(60) Provisional application No. 62/611,732, filed on Dec. 29, 2017.

(51) Int. Cl. G06K 9/00; G06T 7/70; G06Q 10/06

(52) U.S. Cl. CPC G06K 9/00671; G06T 7/70; G06F 16/252; G06Q 10/06316; G06Q 10/063114

(57) ABSTRACT

An augmented reality platform can triangulate location data using a variety of photographic and global positioning system (GPS) data to be able to overlay complex task and shift fulfillment data that is only visible to certain personnel based on qualification criteria that are unique to a particular task, shift and/or job. In certain embodiments, an augmented reality (AR) platform and/or module can isolate location data to be able to better account for location using a variety of photographic and/or tagging techniques, videos, historical motion pathway, and GPS systems to breakout indoor and external positioning. An augmented reality platform can utilize an AR engine to push content to various augmented reality devices within a network and allow the augmented reality platform the ability to leverage AR content to assign tasks, disseminate notes pertaining to a particular task, assist in task completion and facilitate in filling open shifts to qualified personnel.

### CROSS-REFERENCE TO RELATED APPLICATIONS

This patent application claims priority to U.S. Prov. Pat. App. Ser. No. 62/611,732, filed Dec. 29, 2017, entitled Systems and Methods for Integrated Augmented Reality, which is hereby incorporated by reference for all purposes.

### BACKGROUND

### Technical Field

The present disclosure relates generally to augmented reality and more particularly, but not by way of limitation, to systems and methods for integrated augmented reality.

### Background

Augmented or mixed reality is a technology that allows virtual imagery to be mixed with a user's actual view of the real world. A near-eye display may be worn by a user to view the mixed imagery of real objects and virtual objects displayed in the user's field of view. A see-through augmented reality display allows a user interface (UI) to be overlaid on top of a user's view of a real world environment, and a problem emerges of having UI elements appear out-of-context with the real-world environment or situation. Such out-of-context images can mark a distracting user experience in interacting with the UI rather than an experience integrated with a real world environment.

UI that may be worn by users are well known. For example, U.S. Pat. No. 9,897,808, which is incorporated herein by reference, discloses smart glasses having a transparent display to allow a user to see the real world while also viewing images displayed on the smart glass. Overlaying virtual images onto displays of a real-world environment are also well known, such as, for example, shown in U.S. Pat. Pub No. 2014/0214547, which is incorporated herein by reference. For example, U.S. Pat. No. 9,626,070, which is incorporated herein by reference, discloses a location based augmented reality system for exchange of items based on location sensing methods. Augmented reality and image overlays have been used to train employees on how to do certain tasks and to facilitate restocking of inventory on retail shelves. For example, U.S. Pat. Pub No. 2016/0267808, which is incorporated herein by reference, discloses a method for providing training by superimposing computer generated objects over a live camera view to generate a simulated training scenario. For example, U.S. Pat. No. 8,009,864, which is incorporated herein by reference, discloses a method for making a determination of inventory conditions based on image processing. Image processing has also been used to determine a location of a user inside of a building. For example, U.S. Pat. No. 8,488,021, which is incorporated herein by reference, discloses a method of determining a position of a user based on photographs taken by a user device.

### SUMMARY OF THE INVENTION

An augmented reality (AR) platform can triangulate location data using a variety of photographic and global positioning system (GPS) data to be able to overlay complex task and shift fulfillment data that is only visible to certain personnel based on qualification criteria that are unique to a particular task, shift, and/or job. In certain embodiments, an AR platform and/or module can isolate location data to be able to better account for location using a variety of photographic and/or tagging techniques, videos, historical motion pathway, and GPS systems to breakout indoor and external positioning. An AR platform can utilize an AR engine to push content to various AR devices within a network and allow the AR platform the ability to leverage AR content to assign tasks, disseminate notes pertaining to a particular task, assist in task completion and facilitate in filling open shifts to qualified personnel.

In certain embodiments, an AR platform and/or module may utilize a method wherein a first step involves isolating location data to be able to better account for the location using a variety of photographic/tagging, videos, historical motion pathway, and GPS systems to break out indoor and external positioning. In a second step, managers may be able to create AR content and tie to a location filter that can be both indoors or outdoors. The process can begin by first taking a photograph of the location and tagging it or pre-selecting from a list of pre-tagged internal locations. The next screen can allow the manager to tap into the employer platform to be able to first push the task or shift that they would like fulfilled including any of the conditional filters that they would like to use to limit the access of the shift. The manager then can access the content database or create a video describing the task and/or additional content and that can be left to be picked up by anyone certified coming in and out of the location. The manager can also push the task at specific people and that is sent to them via the platform. In a third step, a worker can walk up to a location and based on the location capture in Step 1, they can be pushed into the first filter. Then, a secondary filter can be an access point to the shift matching system and worker profile database that are pinged from the account to account for the filters associated with the tasks. The system can compute and adjust real-time and maintain time-based bounding for pick-up of different shifts and tasks, and the matching computation can run around a rules engine ensuring a proper match without setting off employer triggers for overtime, insufficient match, etc. In a fourth step, a worker can then be pushed a notification that there are Augmented Shifts available around them once a location and certification filter is cleared and they are moved into a matched location pool. In a fifth step, upon clicking the notification, the app can open up to the AR-enabled camera view and an icon can hover on optical recognition of the location. To enable the optical match, video camera can run through a match of the location metadata, a deep-learning model that is running real-time location can match through computation of visual similarity, location tagging repository unique to that employer, and the manager location metadata. In a sixth step, clicking the icon and accepting the task can automatically add all AR content to the phone native memory and creates a sequence of tasks and visual filters that may be linked to the task. In a seventh step, fulfillment of the task can happen directly within the application by using the AR filter to mark sub-sections as complete and accessing content to aid in completion that are tied to the location/task.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 illustrates an example system for task matching and information handling utilizing augmented reality content.

### DETAILED DESCRIPTION

In various embodiments, an augmented reality platform can triangulate location data using a variety of photographic and global positioning system (GPS) data to be able to overlay complex task and shift fulfillment data that is only visible to certain personnel based on qualification criteria that are unique to a particular task, shift and/or job. In certain embodiments, an augmented reality (AR) platform and/or module can isolate location data to be able to better account for location using a variety of photographic and/or tagging techniques, videos, historical motion pathway, and GPS systems to breakout indoor and external positioning. Further, the ability to distribute route clusters inside a location can be a powerful way of using image recognition and constant stream capture of a front-facing camera to triangulate positions that would historically be very difficult for GPS to capture.

In various embodiments, shift owners are able to create AR content and tie that content to a location filter that can be indoors and/or outdoors. The process can begin by first taking a photograph of the location and tagging it, or pre-selecting from a list of pre-tagged internal locations. In certain embodiments, the shift owner can then be taken to a screen allowing the shift owner to utilize an employer platform to be able to first push the task or shift to be fulfilled, including any conditional filters to limit the access of the shift or task, to a matching system. The shift owner can then access the content database or create a video describing the task and/or additional content that can be left to be picked up by anyone certified by the matching system coming in and/or out of the location. In some embodiments, the shift owner can also push the task to specific personnel via the employer platform.

In certain embodiments, when potential personnel approach a location based on the location capture detailed above, the potential personnel are pushed into a first filter (e.g. a location-based filter), or matching, system. In some embodiments, a secondary filter can be accessed by a matching system that includes profiles for personnel within a resource database and can be filtered out based on rule-sets associated with the shift or task. In some embodiments, an employer system computes, adjusts and maintains, in real-time, different shifts and tasks, and the potential matching computations run per a rules engine to ensure proper matching of personnel without setting off employer triggers, for example, overtime, insufficient certifications, lack of training and the like. In other embodiments, the system can maintain time-based bounding to facilitate in task retrieval.

In some embodiments, personnel are pushed a notification that there are “augmented shifts” available around a particular area once location and certification filters have been activated and personnel are moved into a matched location pool. In some embodiments, upon clicking the notification, an application can open to an AR-enabled camera view and an icon can hover over particular areas utilizing optical recognition of the location. In various embodiments, to enable the optical match, a video camera runs through a match of the location metadata and/or a deep-learning model, running in real-time, that can match through computations of visually similar areas, a location tagging repository unique to specific personnel and/or the shift owner location metadata.

In various embodiments, clicking the icon and accepting the task or shift automatically adds all AR content to the native memory of a device and creates a sequence of tasks and visual filters that may be linked to the task. Fulfillment of the task can happen directly within the application by using an AR filter to mark sub-sections as complete and accessing content to aid in the completion of the task in a particular location.

In some embodiments, inventory assignments in merchandising and/or inventory stock control in a retail environment can show the potential detailed stock of each shelf. One way to approach inventory assignments might involve manually checking off boxes against a desired layout. This type of approach would also involve highly manual processes for determining stock inventory, especially if there are changes to a layout or planogram. Advantageously, in certain embodiments, personnel can use AR content to pick up the stock of inventory in a retail location and be able to see exactly where each item is supposed to go and in what order the merchandise should be placed, as the AR overlay on top of the empty shelves would show a fully stocked shelf with the right products in the correct place.

In various embodiments, job postings outside of a location can be made available to potential personnel that match with open shift opportunities near a business location looking for specific type of work, and the personnel would immediately get an alert for an open shift and be able to use a device, for example, a smart-device and an AR overlay, to view the job posting, manager-created video content, have the ability to apply and/or schedule an interview, all directly from the AR-led interface outside of the business location.

In certain embodiments, mystery shoppers outside of a retail store would be able to receive mystery shopping opportunities that exist within a store where they would quickly be able to see products that desire a mystery shop or a price audit and other micro-tasks that can be laid out to a distributed workforce within a retail environment.

In other embodiments, personnel involved in hospital or hotel clean-up that are making their internal rounds within a location with multiple rooms could be alerted to specific tasks associated with each room and what function needs to be performed there. For example, personnel could target multiple rooms within a hospital ward, without receiving asynchronous pings from management, by simply being able to see AR overlays of tasks in each section of the wing and knowing exactly what needs to be accomplished in each location.

In certain embodiments, a doctor or nurse is able to use a manager interface of an application to leave behind specific notes on the bed-side of each patient, much like a clipboard, detailing medical history and other form-specific information. However, utilizing AR content, the assessments and notes can be far more detailed and do not have to be specifically tied to the patient, but instead could be tied to the location and could only be accessible to personnel with certain types of certifications, thus providing a higher level of security and the privacy that is needed for medical information compared to that of an open clipboard. Further, this form of AR content overlay for private information can be used to quickly pass off information to rotating groups of contingent personnel, such as nurses and medical residents, where the flow of information is location and certification specific. In this embodiment, the front-facing camera with access to credential certification can be useful for driving meaningful controls for information creating and sharing.

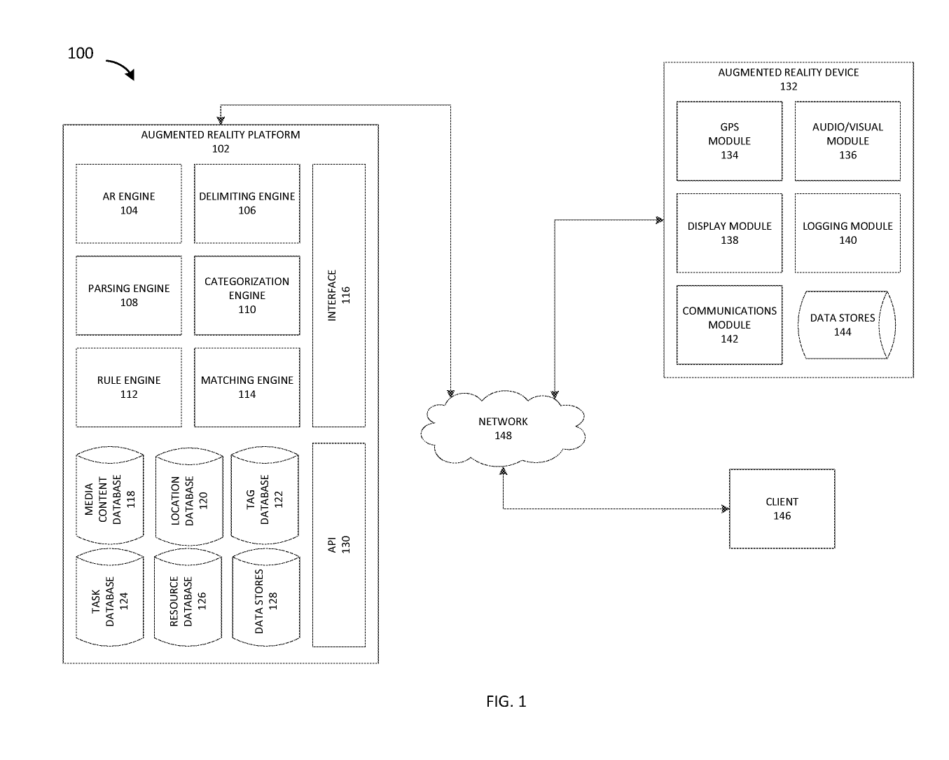

FIG. 1 illustrates an example system 100 for task matching and information handling utilizing augmented reality content. The system 100 includes an augmented reality platform 102, an augmented reality device 132 and a client 146 communicatively coupled by a network 148. In certain embodiments, there are a plurality of augmented reality platforms, a plurality of augmented reality devices and a plurality of clients on the network 148. In certain embodiments, the augmented reality platform 102 includes an AR engine 104, a delimiting engine 106, a parsing engine 108, a categorization engine 110, a rule engine 112, a matching engine 114, an interface 116, a media content data base 118, a location database 120, a tag database 122, a task database 124, a resource database 126, data stores 128 and an application programming interface (API) 130. In certain embodiments, the network 148 can be a local area network (LAN), a personal area network (PAN), a wireless local area network (WLAN), a wide area network (WAN), mobile/cellular networks and the like.

In certain embodiments, the AR engine 104, the delimiting engine 106, the parsing engine 108, the categorization engine 110, the rule engine 112, the matching engine 114, the interface 116 and the API 130 can reside within the data stores 128. In other embodiments, the AR engine 104, the delimiting engine 106, the parsing engine 108, the categorization engine 110, the rule engine 112 and the matching engine 114 can be a single engine or a plurality of engines spanning across the network 148 and can reside in, or be part of, a plurality of augmented reality platforms. In some embodiments, the delimiting engine 106, the parsing engine 108, the categorization engine 110, the rule engine 112, the matching engine 114, the task database 124, the resource database 126 and the API 130 can be a separate task and/or matching platform residing outside of the augmented reality platform 102. In these embodiments, the augmented reality platform 102 can be operable to communicate with the matching platform via the API 130 over the network 148. In particular embodiments, a corresponding AR engine can reside in the augmented reality device 132 to reduce both data transfer over the network 148 and computation resources of the augmented reality platform 102. For example, the augmented reality device 132 can receive only relevant data from the augmented reality platform 102 and data contained in the media content database 118, the location database 120, the tag database 122 and relevant portions of the task database 124 can be transferred to the augmented reality device 132 to be stored in data stores and utilize the corresponding AR engine for overlaying complex task and shift fulfillment thereby reducing computational resources of the augmented reality platform 102.

In certain embodiments, the media content database 118, the location database 120, the tag database 122, the task database 124 and the resource database 126 can reside in a single data store, for example, the data stores 128. In other embodiments, the media content database 118, the location database 120, the tag database 122, the task database 124 and the resource database 126 can reside in a plurality of data stores spanning across the network 148. In some embodiments, the media content database 118, the location database 120, the tag database 122, the task database 124 and the resource database 126 can reside in a central data store residing outside of the augmented reality platform 102. For example, the augmented reality platform 102 could be operable to communicate with the central data store via the API 130 over the network 148.

In various embodiments, the media content database 118 can store all relevant media, for example, audio, video and photographic data corresponding to a particular task or shift, within the task database 124. In some embodiments, the media content database 118 stores video and/or audio instructions and training information, video and/or audio records relevant to task or shift completion, general video and/or audio information such as shift information, video and/or audio tasks or job postings, video and/or pictures of inventory layouts and/or changes to inventory layouts (e.g. planograms), video and/or audio medical notes regarding patient data, video and/or pictures for room clean-up in various hospitality service industries and the like. In some embodiments, the location database 120 stores all relevant location information pertaining to a task and/or shift. For example, if a job posting is stored in the task database 124, a corresponding location for the job posting can be stored in the location database 120. In some embodiments, the matching engine 114 can invoke the API 130 to send push notifications to the augmented reality device 132 when a user of the augmented reality device 132 is within a certain range of the coordinates stored within the location database 120. In certain embodiments, the tag database 122 stores all relevant tagging data and/or metadata associated with a task and/or shift within the task database 124. In various embodiments, the tagging data stored in the tag database 122 contains all relevant information pertaining to a corresponding task and/or shift within the task database 124, for example, certifications required, security restrictions, type of task and/or job, wage data, time needed, estimated length of a specific task, training requirements, experience needed, employer information such as company name, industry and/or corporate statistics, and the like.

In various embodiments, the task database 124 includes all tasks available within the system 100. In certain embodiments, the task database 124 can include all tasks, shifts and/or jobs that are currently in a designated state, for example, an “active”, “passive” or “closed” state. In various embodiments, an “active” state can refer to a shift, task and/or jobs that are currently open to potential personnel, for example, a job opening at a local convenience store, such that AR data relating to the job opening can be available to potential personnel that the matching engine 114 has deemed qualified. In certain embodiments, a “passive” state can refer to a shift that has multiple people assigned, however is not freely open for potential personnel to join, for example, in a hospital setting where a patient has been assigned a certain number of doctors, each doctor would be identified as being assigned to that patient and/or room (i.e. shift) such that AR data can be shared among the assigned doctors only. In a related embodiment, the “passive” state can also be an indication that, while the shift is technically in a “closed” state in the sense that it has been fully assigned, personnel that meet the qualifications as determined by the matching engine 114 can “swap-out” with personnel currently participating in the shift. Referring back to the example of the assigned doctors, when it is time for an assigned doctor to either leave or transfer ownership of the shift to another doctor, the matching engine 114 can allow for a replacement of personnel for that given shift. In other embodiments, a “closed” state can refer to a shift, task and/or job that has either ended or has been filled. In various embodiments, the “closed” state can allow for personnel who were previously assigned to the task, shift and/or job that has now been assigned a “closed” state to review records and various information in relation to the task, shift and/or job that the personnel were participants of. In various embodiments, the resource database 126 stores personnel records for each person within the system 100. In various embodiments, the resource database 126 stores all relevant personnel data, for example, training, qualifications, education, wage requirements, availability, and the like.

In some embodiments, the AR engine 104 is operable to create a live direct and/or indirect view of physical, real-world environments with various elements augmented onto a display of the augmented reality device 132. In certain embodiments, the AR engine 104 can utilize sensory input data, for example, sound, video, graphics, haptic perception, GPS data and the like. In some embodiments, the AR engine 104 can derive real-world coordinates, independent from hardware residing within the augmented reality device 132, using images alone by leveraging image registration and methods of computer vision and video tracking. In some embodiments, the AR engine 104 can detect interest points, fiducial markers or optical flow in images. This process can include feature detection methods such as corner detection, blob detection, edge detection, thresholding, various image processing methods, and the like. In various embodiments, the AR engine 104 restores a real-world coordinate system from the data obtained from the various above-mentioned methods. In various embodiments, the AR engine 104 assumes objects with known geometry or fiducial markers are present in the image, and pre-processes three-dimensional structures. In some embodiments, if part of the scene in the image is unknown, simultaneous localization and mapping (SLAM) can map relative positions. In other embodiments, if no information about scene geometry is available, structure from motion methods like bundle adjustment can be utilized. In various embodiments, the AR engine 104 can utilize various mathematical methods, for example, projective (epipolar) geometry, geometric algebra, rotation representation with exponential map, kalman and particle filters, nonlinear optimization, robust statistics and the like.

In certain embodiments, the delimiting engine 106 can be utilized to facilitate separation of input data, for example, media content stored in the media content database 118, task and resource data stored in the task database 124 and the resource database 126, respectively, tagging data and/or metadata stored in the tag database 122 and location data stored in the location database 120. In various embodiments, the delimiting engine 106 includes natural language processing algorithms, optical character recognition (OCR) algorithms, speech-to-text recognition algorithms, optical resolution mapping algorithms and the like. In some embodiments, the delimiting engine 106 can be preconfigured to recognize breaking points, for example, commas and/or tabs in raw text inputs or pauses between sentences in speech-to-text input. In other embodiments, the delimiting engine 106 can be preconfigured to recognize patterns in media content inputted to be stored in the media content database 118. In some embodiments, data is separated based on delimiting factors and prepared for categorization by the categorization engine 110. In various embodiments, the delimiting engine 106 can be configured to separate specific parts of the media content, for example, company data can be inputted via an image containing relevant and non-relevant company data, then processed, by the delimiting engine 106 via OCR technology and delimiter recognition to parse out only the relevant company data, for example, the company location. In some embodiments, the speech-to-text input can be received via a “digital assistant” (e.g. ALEXA, GOOGLE ASSISTANT, SIRI and the like) available to a user, via the augmented reality device 132 and/or the client 146. In some embodiments, the augmented reality platform 102 can temporarily store delimited content in the data stores 128 for further processing when system resources are customarily utilized less. In some embodiments, data can be processed by the delimiting engine 106 and the parsing engine 108, and can then be sent to the categorization engine 110 to be categorized and stored in the task database 124 and/or the resource database 126. In a similar fashion, in some embodiments, media content can be processed by the delimiting engine 106 and the parsing engine 108, and can then be sent to the categorization engine 110 to be categorized and stored in the media content database 118, the location database 120 and the tag database 122.

In certain embodiments, the matching engine 114 can be utilized to determine specific personnel that match specific constraints required by a task, shift and/or job stored within the task database 124 by leveraging the rule engine 112. In some embodiments, specific constraints can be geographical limitations, required certifications, training, availability, current location, scheduling data related to personnel and the like, which can be stored in the task database 124 and/or the tag database 122 and received by the rule engine 112. In various embodiments, the matching engine 114 can pull information from the resource database 126 and correlate personnel data with the task constraints received by the rule engine 112 to determine matching personnel for a specific task, shift and/or job.

In certain embodiments, the augmented reality device 132 can include a GPS module 134, an audio/visual module 136, a display module 138, a logging module 140, a communications module 142 and data stores 144. In some embodiments, the augmented reality device 132 can reside as a software module leveraging existing hardware, for example, a module incorporated into smart-device, or can be a stand-alone device including a combination of hardware and software. In certain embodiments, the augmented reality device 132 can be AR eyeglasses, smart-phones, smart-watches, virtual retinal displays, handheld devices, spatial augmented reality (SAR) devices, tablet computers, a head-up display (HUD) and the like. In certain embodiments, the GPS module 134 can leverage the logging module 140 to isolate location data of the augmented reality device 132 by storing a log of all location data of the augmented reality device 132 within the data stores 144. In some embodiments, the communications module 142 can push the location data to the location database 120 of the augmented reality platform 102 to ensure that all location data is synced among all devices accessing the augmented reality platform 102, for example, the client 146. In various embodiments, the GPS module 134 can leverage the communications module 142 for example, by utilizing wireless networks connected via the communications module 142 to isolate the location of the augmented reality device 132 when the augmented reality device 132 is indoors or other areas where GPS data is not as readily accessible by the augmented reality device 132. In some embodiments, the logging module 140 can create a customized historical motion pathway of the augmented reality device 132 by leveraging both the GPS module 134 and the communications module 142.

In various embodiments, the audio/visual module 136 can include an interface for hardware cameras, microphones, video recorders, audio recorders, and the like. In certain embodiments, the audio/visual module 136 can store input data within the data stores 144. In other embodiments, the audio/visual module 136 can leverage the logging module 140 to create logs for each interaction with any of the hardware components controlled by the audio/visual module 136. In certain embodiments, the display module 138 can be utilized to display AR data from the AR engine 104 onto a hardware display controlled by the display module 138. In various embodiments, the display module 138 can be in direct communication with the AR engine 104 via the communications module 142 allowing for real-time AR overlay displays produced by the AR engine 104. In other embodiments, the communications module 142 receives data from the AR engine 104 and stores the data within the data stores 144 to be displayed at a later time, while offline or for buffering incoming data going to the display module 138.

In certain embodiments, the client 146 can include, for example, thin clients, desktop computers, laptop computers, tablet computers, smart phones, wearable or body-borne computers, and the like. In further embodiments, the client 146 can be a plurality of clients on the network 148. In various embodiments, the client 146 can be operable to run an application that can directly connect to the augmented reality platform 102 via the interface 116 over the network 148. In various embodiments, the augmented reality platform 102 and/or the communications module 142 of the augmented reality device 132 can have various interface protocols, for example, transmission control protocol and the internet protocol (TCP/IP), user datagram protocol (UDP) and the like, such that the augmented reality platform 102 and the augmented reality device 132 residing on the network 148 can send and receive data with all components on the network 148.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A computer-implemented method, comprising:
storing a task needing to be performed in a database;
associating a plurality of criteria with the task;
capturing a scene picture associated with a location;
creating augmented reality (AR) content for overlaying over the scene picture to thereby generate an augmented reality image related to the task needing to be performed;
identifying, at an client terminal, location information for a user;
using the location information to determine if the user is within a predetermine distance of the location;
providing the AR content to the user including instructions for performing the task; and
following performance of the task, receiving an image from the user verifying completion of the task.
